(19) United States
(12) Patent Application Publication
(10) Pub. No.: US 2007/0103618 A1
(43) Pub. Date: May 10, 2007

(54) Polarizer plate and liquid crystal panel using the same

(75) Inventor: Jui-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/595,373

(22) Filed: Nov. 10, 2006

(30) Foreign Application Priority Data
Nov. 10, 2005 (CN) 200510101211

(51) Int. Cl. G02F 1/1335

(52) U.S. Cl. 349/96

(57) ABSTRACT

A polarizer plate (210) in order has a protection film (211); a polarization main body (212), having an absorption axis (2120); and a wide view film (213), having a discotic liquid crystal layer. The discotic liquid crystal layer has a plurality of discotic liquid crystal moleculars, which are aligned in a direction (2133) maintaining an angle relative to the absorption axis.

### FIELD OF THE INVENTION

The present invention relates to a polarizer plate for a liquid crystal panel.

### GENERAL BACKGROUND

Because liquid crystal display devices have the merits of being thin, light in weight, and drivable by a low voltage, they are extensively employed in various electronic devices. A typical LCD device 100 as shown in FIG. 5 includes a first substrate 120, a second substrate 140, and a liquid crystal layer 130 interposed between the first and second substrates 120, 140. A first and a second polarizer plates 110, 150 are provided at two outsides of the first and second substrates 120, 130. The first and the second polarizer plates 110, 150 have same structure.

As shown in FIG. 6, The first polarizer plate 110 includes a first protection film 111, a polarization main body 112, a wide view film 113, an adhesive layer 114, and a release layer 115, in that order from top to bottom. The first protection film 111 is highly transparent and waterproof, which enable them to support and protect the polarization main body 112. The release layer 115 is used to keep the adhesive layer 114 clean and sticky. In use, the release layer 115 is peeled off, and the polarizer plate 110 is attached to one or more other elements of a liquid crystal panel by the adhesive layer 114. The p polarization main body 112 has an absorption axis 1120, which maintains a 45 degrees angle relative to a longer side of the polarization main body 112, being parallel to an alignment direction of the first substrate 120. The wide view film 113 has a second protective film 1130, an alignment layer 1131 and a discotic liquid crystal molecular layer 1132. An alignment direction 1133 of the plurality of liquid crystal moleculars of the discotic liquid crystal molecular layer 1132 is parallel to the absorption axis 1120. The second polarizer plate 150 has a similar structure to that of the first polarizer plate 110, except an absorption axis of the second polarizer plate 150 being perpendicular to the absorption axis 1120 of the first second polarizer plate 110.

Referring to FIG. 7, the optical compensation theory of the wide view film 113 is shown. Liquid crystal molecular 1301 of the liquid crystal layer 130 has three refractive indices of N_{X}, N_{Y}, and N_{Z} in three direction of X axis, Y axis, and Z axis, which have the relationship of N_{Z}<N_{X}=N_{Y}. The discotic liquid crystal molecular 1134 of the wide view film 113 also has three refractive indices of n_{X}, n_{Y}, and n_{Z} in three direction of X axis, Y axis, and Z axis. The three refractive indices of the liquid crystal molecular 1301 and the three refractive indices of the discotic liquid crystal molecular 1134 of the wide view film 113 satisfy the aftermentioned formula: N_{Z}+n_{Z}=N_{X}+n_{X}=N_{Y}+n_{Y}. Therefore, the wide view film 113 can efficiently compensate the different light beams retardation brought by the irregularly alignment of the liquid crystal molecular 1301 and resolve the lower viewing angle.

However, the LCD device 100 generally realizes high contrast ratio through adjusting the voltages for dark or white display in a predetermined range. When the liquid crystal layer 130 is provided a voltage larger than a threshold voltage, a phenomena of gray level inversion is produced and the LCD device has a lower viewing angle, because the alignment direction 1133 of the discotic liquid crystal molecular 1134 is parallel to the absorption axis 1120.

What is needed, therefore, is a polarizer plate that overcomes the above-described deficiencies.

### SUMMARY

In a preferred embodiment, a polarizer plate in order has a protection film; a polarization main body, having an absorption axis; and a wide view film, having a discotic liquid crystal layer. The discotic liquid crystal layer has a plurality of discotic liquid crystal moleculars, which are aligned in a direction maintaining an angle relative to the absorption axis.

In another preferred embodiment, a liquid crystal panel has a first substrate; a second substrate; a liquid crystal layer disposed between the substrates; and a first polarizer plate arranged at an outer surface of the first substrate. The first polarizer plate has a protection film; a polarization main body, having an absorption axis; and a wide view film, having a discotic liquid crystal layer. The discotic liquid crystal layer has a plurality of discotic liquid crystal moleculars, which are aligned in a direction maintaining an angle relative to the absorption axis.

Other advantages and novel features will become more apparent from the following detailed description when taken in conjunction with the accompanying drawings.

### BRIEF DESCRIPTION OF THE DRAWINGS

FIG. 1 is a schematic view of a liquid crystal panel according to a first embodiment of the present invention, which has a first polarizer plate.

FIG. 2 is a schematic view of the first polarizer plate of FIG. 1.

FIG. 3 is a schematic view of another liquid crystal panel according to a second embodiment of the present invention, which has a second polarizer plate.

FIG. 4 is a schematic view of the second polarizer plate of FIG. 1.

FIG. 5 is a schematic view of a conventional liquid crystal panel, which has a first polarizer plate and a wide view film.

FIG. 6 is a schematic view of the first polarizer plate of FIG. 5.

FIG. 7 illustrates the optical compensation theory of the wide view film of FIG. 5.

### DETAILED DESCRIPTION OF PREFERRED EMBODIMENTS

FIG. 1 shows a schematic view of a liquid crystal panel according to a first embodiment of the present invention. The liquid crystal panel 200 has a first polarizer plate 210, a first substrate 220, a liquid crystal layer 230, a second substrate 240, and a second polarizer plate 250, which are sequentially disposed in that order from top to bottom.

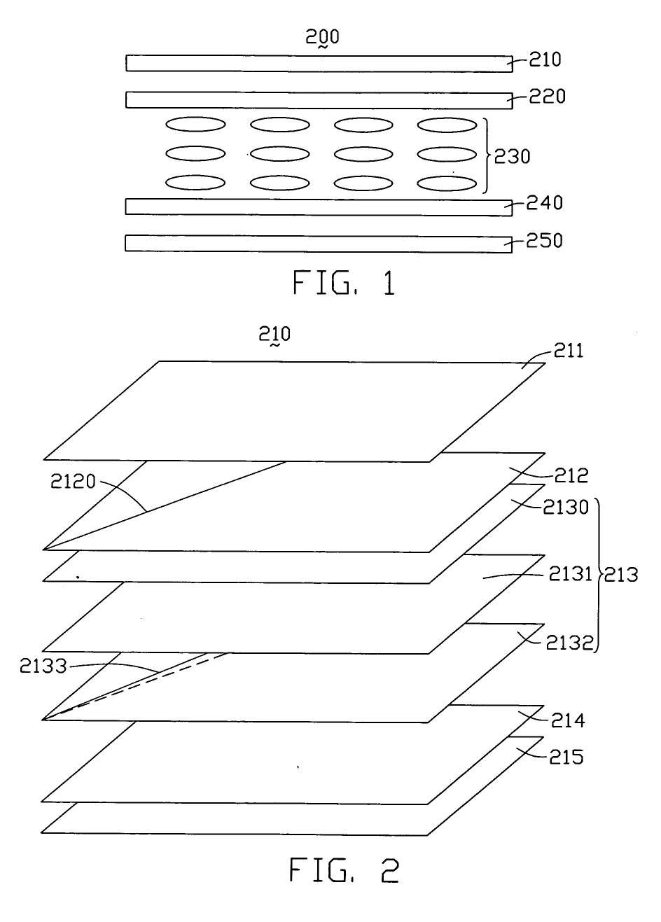

FIG. 2 is a schematic view of the first polarizer plate 210 of the liquid crystal panel 200. The polarizer plate 210 includes a first protection film 211, a polarization main body 212, a wide view film 213, an adhesive layer 214, and a release layer 25, in that order from top to bottom. The first protection film 211 covers and protects the polarization main body 212. The release layer 215 is to keep the adhesive layer 214 clean and sticky. In use, the polarizer plate 200 is adhered to one or more other elements of the first substrate 220 by the adhesive layer 214. The polarization main body 213 is made from polyvinyl alcohol mixed with iodine molecules, or polyvinyl alcohol mixed with iodine molecules and potassium iodide, which has an absorption axis 2120. The absorption axis 2120 maintains a 45-degree angle relative to a longer side of the polarization main body 212, and which is parallel to an alignment direction of the first substrate 220.

The wide view film 213 has a second protection film 2130, an alignment layer 2131 and a discotic liquid crystal layer 2132, which are sequentially disposed in that order from top to bottom. The discotic liquid crystal layer 2132 has a plurality of discotic liquid crystal molecular, which are oriented at an alignment direction 2133. The alignment direction 2133 of the discotic liquid crystal molecular clockwise maintains a 2-degree angle relative to the absorption axis 2120 of the polarization main body 212.

The liquid crystal panel 200 utilize the discotic liquid crystal molecular having a predetermined alignment direction of the wide view film 213 to compensate the retardation and influence the polarization state of the light beams transmitting the liquid crystal layer 230. Therefore, the liquid crystal panel 200 can efficiently improve the contrast ratio and keep a large viewing angle.

In addition, the alignment direction 2133 of the discotic liquid crystal molecular may maintain an angle of 1 degree, 3 degrees, or 1 degree to 3 degrees relative to the absorption axis 2120 of the polarization main body 212. The liquid crystal panel 200 can also efficiently improve the contrast ratio and keep a large view angle.

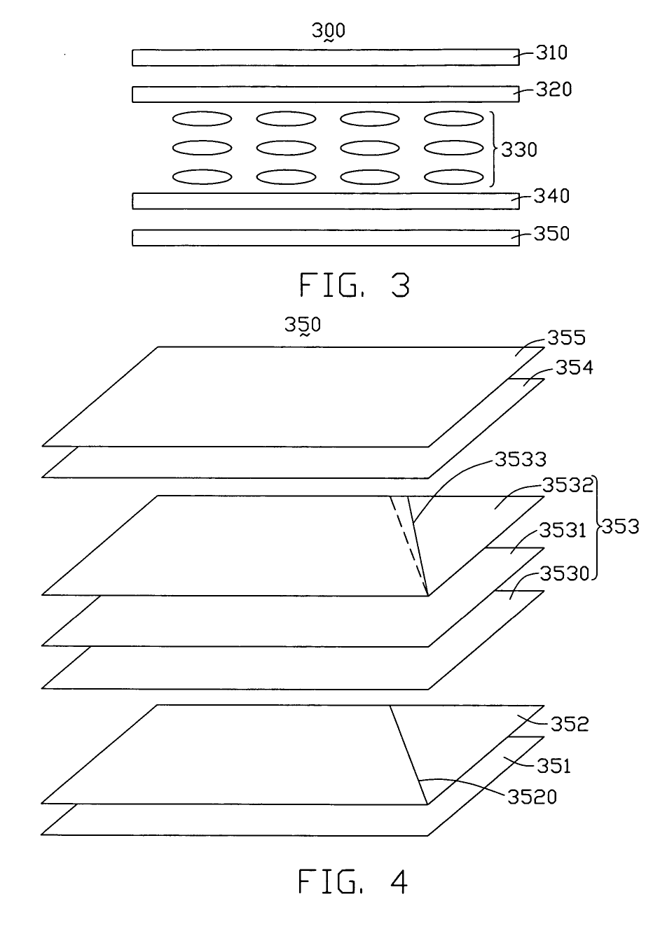

FIG. 3 shows a schematic view of a liquid crystal panel according to a second embodiment of the present invention. The liquid crystal panel 300 has a first polarizer plate 310, a first substrate 320, a liquid crystal layer 330, a second substrate 340, and a second polarizer plate 350, which are sequentially disposed in that order from top to bottom.

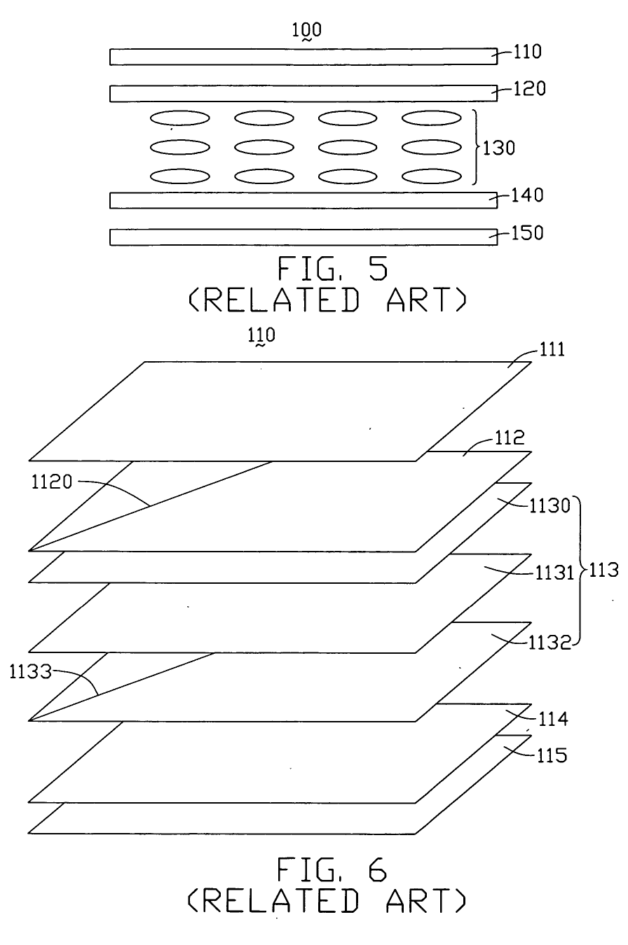

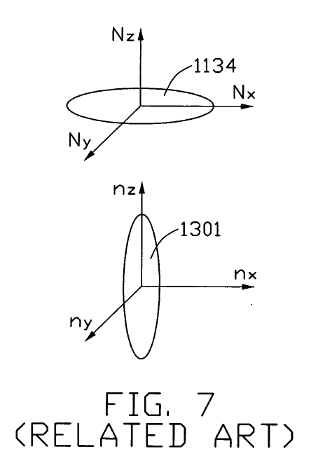

FIG. 4 is a schematic view of the second polarizer plate 350 of the liquid crystal panel 300. The polarizer plate 350 includes a first protection film 351, a polarization main body 352, a wide view film 353, an adhesive layer 354, and a release layer 355, in that order from bottom to top. The first protection film 351 covers and protects the polarization main body 352. The release layer 355 is to keep the adhesive layer 354 clean and sticky. In use, the polarizer plate 350 is adhered to the second substrate 340 by the adhesive layer 354. The polarization main body 352 is made from polyvinyl alcohol mixed with iodine molecules, or polyvinyl alcohol mixed with iodine molecules and potassium iodide, which has an absorption axis 3520. The absorption axis 3520 maintains 135 degrees relative to a longer side of the polarization main body 352, and which is parallel to an alignment direction of the second substrate 340.

The wide view film 353 has a second protection film 3530, an alignment layer 3531 and a discotic liquid crystal layer 3532, which are sequentially disposed in that order from bottom to top. The discotic liquid crystal layer 3532 has a plurality of discotic liquid crystal moleculars, which are oriented at an alignment direction 3533. The alignment direction 3533 of the discotic liquid crystal molecular counter clockwise maintains a 2-degree angle relative to the absorption axis 3520 of the polarization main body 352.

The liquid crystal panel 300 utilize the discotic liquid crystal molecular having a predetermined alignment direction of the wide view film 313 to compensate the retardation and influence the polarization state of the light beams transmitting the liquid crystal layer 330. Therefore, the liquid crystal panel 300 can efficiently improve the contrast ratio and keep a large viewing angle.

In addition, the alignment direction 3533 of the discotic liquid crystal molecular may maintain an angle of 1 degree, 3 degrees, or 1 degree to 3 degrees relative to the absorption axis 3520 of the polarization main body 352. The liquid crystal panel 300 can also efficiently improve the contrast ratio and keep a large view angle.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A polarizer plate, comprising in order:
a protection film;
a polarization main body, having an absorption axis; and
a wide view film, having a discotic liquid crystal layer;
wherein the discotic liquid crystal layer has a plurality of discotic liquid crystal molecular, which are aligned in a direction maintaining an angle relative to the absorption axis.

2. The polarizer plate as claimed in claim 1, wherein the plurality of discotic liquid crystal molecular is aligned in a direction maintaining an angle of 2 degrees relative to the absorption axis.

3. The polarizer plate as claimed in claim 1, wherein the plurality of discotic liquid crystal molecular is aligned in a direction maintaining an angle of 1 degrees relative to the absorption axis.

4. The polarizer plate as claimed in claim 1, wherein the plurality of discotic liquid crystal molecular is aligned in a direction maintaining an angle of 3 degrees relative to the absorption axis.

5. The polarizer plate as claimed in claim 1, wherein the plurality of discotic liquid crystal molecular is aligned in a direction maintaining an angle of 1 degree to 3 degrees relative to the absorption axis.

6. The polarizer plate as claimed in claim 1, further comprising an adhesive layer and a release layer, which are sequentially disposed on the wide view film, from top to bottom.

7. The polarizer plate as claimed in claim 1, wherein the wide view film further has an alignment film orienting the alignment direction of the discotic liquid crystal moleculars.

8. A liquid crystal panel, comprising:
a first substrate;
a second substrate;
a liquid crystal layer disposed between the substrates; and
a first polarizer plate arranged at an outer surface of the first substrate, the first polarizer plate comprising a protection film; a polarization main body, having an absorption axis; and a wide view film, having a discotic liquid crystal layer;
wherein the discotic liquid crystal layer has a plurality of discotic liquid crystal molecular, which are aligned in a direction maintaining an angle relative to the absorption axis.

9. The liquid crystal panel as claimed in claim 8, wherein the plurality of discotic liquid crystal molecular is aligned in a direction maintaining an angle of 2 degrees relative to the absorption axis.

10. The liquid crystal panel as claimed in claim 8, wherein the plurality of discotic liquid crystal molecular is aligned in a direction maintaining an angle of 1 degrees relative to the absorption axis.

11. The liquid crystal panel as claimed in claim 8, wherein the plurality of discotic liquid crystal molecular is aligned in a direction maintaining an angle of 3 degrees relative to the absorption axis.

12. The liquid crystal panel as claimed in claim 8, wherein the plurality of discotic liquid crystal molecular is aligned in a direction maintaining an angle of 1 degree to 3 degrees relative to the absorption axis.

13. The liquid crystal panel as claimed in claim 8, further comprising an adhesive layer and a release layer, which are sequentially disposed on the wide view film, from top to bottom.

14. The liquid crystal panel as claimed in claim 8, wherein the wide view film further has an alignment film orienting the alignment direction of the discotic liquid crystal moleculars.

15. A method of making a polarizer plate, comprising steps of:
providing a protection film;
providing a polarization main body defining an absorption axis thereof; and
providing a wide view film with a discotic liquid crystal layer thereon;
wherein the discotic liquid crystal layer has a plurality of discotic liquid crystal molecular, which are aligned along a direction in a non-parallel relation with regard to the absorption axis.
